(19) United States
(12) Patent Application Publication
(10) Pub. No.: US 2004/0163910 A1
(43) Pub. Date: Aug. 26, 2004

(54) Retractable luggage wheel

(76) Inventor: Ki-Bong Lee, Kim Po City (KR)

Correspondence Address: IPSG, P.C., P.O. BOX 700640, SAN JOSE, CA, 95170-0640, US

(21) Appl. No.: 10/727,762

(22) Filed: Dec. 3, 2003

(30) Foreign Application Priority Data
Feb. 14, 2003 (CN) 03219909.0

(51) Int. Cl. A45C 13/30; A45C 13/00; B62D 33/08

(52) U.S. Cl. 190/18 A; 190/115; 280/37

(57) ABSTRACT

A retractable luggage wheel is described. A container (e.g. luggage) wheel control mechanism includes a container handle mechanically coupled to a container, configured to expand and compress, and a container wheel mechanically coupled to the container handle and responsive to movement of the container handle, configured to extend from the surface of the container when the container handle is expanded and to retract from the surface of the container when the container handle is compressed. Advantages of the invention include more compact luggage storage, easier luggage handling, and reduced damage to luggage wheels.

### RELATED APPLICATIONS

This application claims priority to Chinese Patent Application Number 03219909.0 filed Feb. 14, 2003.

### FIELD

The present invention relates to luggage generally and more particularly to carry-on luggage.

### BACKGROUND

Articles of luggage, such as suitcases, are often outfitted with wheels. The luggage wheels enable a traveler to move the luggage more easily because he or she can roll the luggage rather than carry the luggage. Conventionally, the luggage wheels extend out from the surface of the luggage and cannot be retracted. Because the wheels cannot be retracted, the luggage requires more space for storage than would be required if the luggage did not have wheels. In the case of carry-on luggage, the extra space required due to the unretractable wheels may necessitate that the luggage be checked onto the back of the plane rather than fitting into the more convenient overhead bins in the cabin of the plane. Checking the luggage onto the plane creates additional hassles for the traveler and requires additional time. Another problem with the conventional luggage wheels is that they may break more easily because they do not retract. Thus, a retractable luggage wheel is needed.

### SUMMARY

The present invention addresses the disadvantages of the prior art by providing a retractable luggage wheel control mechanism that is easy to operate. The control mechanism is for use on all types of luggage, including carry-on luggage.

A retractable luggage wheel control mechanism (control mechanism) is for use on all types of luggage (containers), including carry-on luggage. In one embodiment of the present invention, movement of a luggage handle (handle) controls the extension and retraction of the luggage wheel.

In one embodiment of the present invention, the control mechanism includes a luggage wheel, a wheel housing, the luggage handle, a slide, and a plurality of springs. The luggage handle may include a pair of telescoping luggage handle shafts, i.e. a left handle shaft and a right handle shaft. Each telescoping luggage handle shaft may include an inner handle shaft and an outer handle shaft. A spring fits inside of the slide. More specifically, the spring fits inside a space on the inside of the slide and attaches to a hook connected to the luggage body. Other springs fit on both sides of the wheel housing.

The top surface of the slide has a top incline surface that slidingly couples with the bottom end of the handle shaft, i.e. the inner handle shaft. The bottom surface of the inner handle shaft may have a handle contact structure to press against and slidingly couple with the top incline surface of the slide. The handle contact structure may be composed of wire and plastic. The bottom surface of the slide has a bottom incline surface to slidingly couple with the top of the wheel housing. A slide cover attaches to the luggage surface to cover and protect the slide.

The disclosed control mechanism provides for easy extension and retraction of luggage wheels. The luggage wheels move in response to compression and expansion of the luggage handle. That is, when the handle is compressed, the wheels extend; and when the handle is expanded, the wheels retract. The movement of the wheels is thus controlled automatically by the operation of the handle. The control mechanism provides for easier luggage handling and storage.

### DESCRIPTION OF THE DRAWINGS

FIG. 1 depicts a frontal view of a dissembled control mechanism;

FIG. 2 depicts a frontal view of an assembled control mechanism;

FIG. 3 depicts a cut-away view of the control mechanism in a “wheel-in” position; and

FIG. 4 depicts a cut-away view of the control mechanism in a “wheel-out” position.

### DETAILED DESCRIPTION

A retractable luggage wheel control mechanism (control mechanism) is for use on all types of luggage (containers), including carry-on luggage. In one embodiment of the present invention, movement of a luggage handle controls the extension and retraction of the luggage wheel.

In one embodiment of the present invention, the control mechanism includes a luggage wheel, a wheel housing, the luggage handle, a slide, and a plurality of springs. The luggage handle may include a pair of telescoping luggage handle shafts, i.e. a left handle shaft and a right handle shaft. Each telescoping luggage handle shaft may include an inner handle shaft and an outer handle shaft. The luggage handle may be comprised of a plurality of pipes or any other type of shaft structure. A spring fits inside of the slide. More specifically, the spring fits inside a space on the inside of the slide and attaches to a hook connected to the luggage body. Other springs fit on both sides of the wheel housing.

The top surface of the slide has a top incline surface that slidingly couples with the bottom end of the handle shaft, i.e. the inner handle shaft. The bottom surface of the inner handle shaft may have a handle contact structure to press against and slidingly couple with the top incline surface of the slide. The handle contact structure may be composed of wire and plastic. The bottom surface of the slide has a bottom incline surface to slidingly couple with the top of the wheel housing. A slide cover attaches to the luggage surface to cover and protect the slide.

Referring now to the figures, the control mechanism includes the wheel 3, the wheel housing 2, the slide 4, the wheel outside cover 14, slide springs 5, wheel springs 6, and the telescoping luggage handle shaft 7. A luggage body 1 houses the control mechanism as well as provides space for clothing or other articles to be stored.

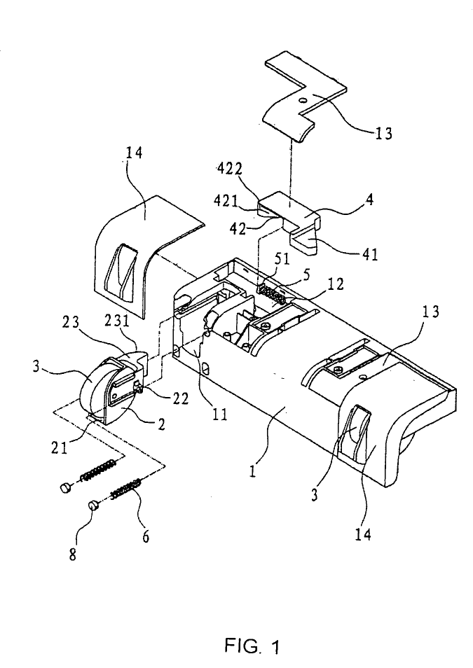

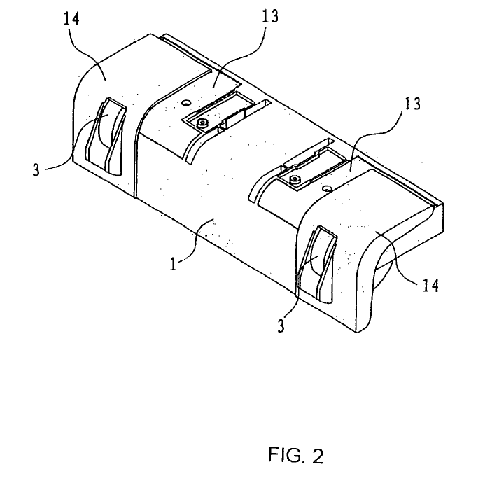

Referring now to FIGS. 1 and 2, the wheel outside cover 14 attaches at a side of the bottom surface of the luggage body. A wheel hole 11 is bored in the center of the wheel outside cover to allow the wheel to travel in and out. The wheel outside cover protects the outer surface of the luggage body, i.e. leather or fabric. The wheel outside cover also provides a rigid, flat surface on which to stand and balance the luggage body.

The luggage body includes a hollow space 12 to house the slide, the wheel housing, and the telescoping luggage handle shaft.

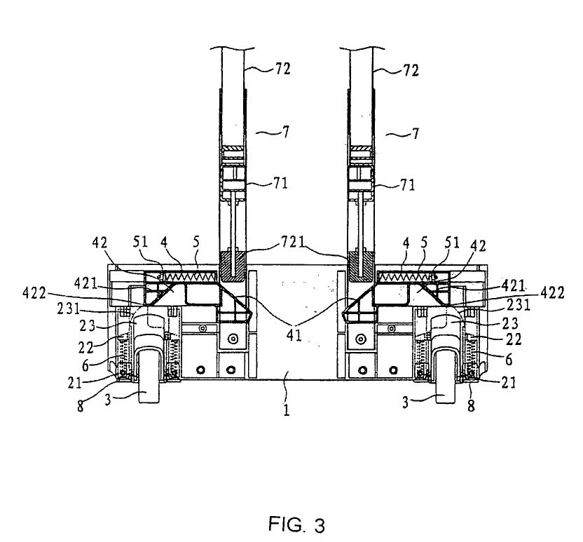

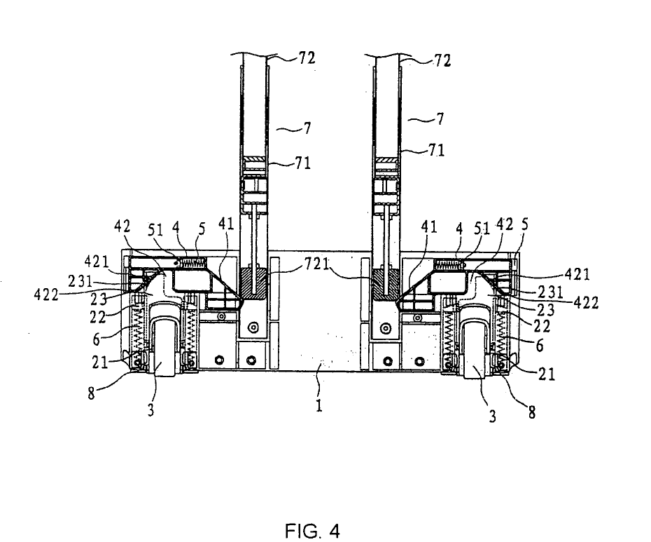

Referring now to FIGS. 3 and 4, the telescoping luggage handle shaft includes the inner handle shaft 72 and the outer handle shaft 71. The bottom end of the inner shaft may include the handle contact structure 721 to press against and slidingly couple to the top incline surface 41 of the slide.

Referring again to FIG. 1, the wheel housing holds the wheel so that the wheel may roll about an axle. The top on the wheel housing may have may have a convex wheel housing contact member 231 to press against and slidingly couple to the bottom incline surface 42 of the slide. A pair of the wheel springs 6 fit into the spring holes 16 on the luggage body (depicted by the pair of dotted lines shown in FIG. 1). A pair of wheel spring caps 8 fit over the wheel springs.

Referring again to FIGS. 3 and 4, the slide holds the slide spring 5 that couples to the hook 51. The top surface of the slide has the top incline surface to slidingly couple to the handle shaft contact member. The bottom surface of the slide has the bottom incline surface to slidingly couple to the convex wheel housing contact member. The bottom incline surface may be part of a slide notch 421 into which the convex wheel housing contact member fits when the control mechanism is in a “wheel in” position. The slide cover 13 attached to the luggage body covers and protects the slide.

Referring now to FIG. 4, the control mechanism is depicted in a “wheel-in” position. When the telescoping luggage handle shaft is compressed, i.e. when the handle is pressed into the luggage, the inner handle shaft slides more deeply into the outer handle shaft. The handle contact structure at the bottom end of the inner handle shaft presses against and slidingly couples to the top incline surface of the slide, thereby moving the slide out of a slide hole 411 in the outer handle shaft. The slide moves outward, away from the center of the luggage body in response to the pressure applied by the handle contact structure. As the slide moves outward, the convex wheel housing contact member slidingly couples to the bottom incline surface of the slide and gradually fits into the slide notch, under the force applied by the pair of wheel springs. As the convex wheel housing contact member fits into the slide notch, the wheel is retracted.

Referring now to FIG. 3, the control mechanism is depicted in a “wheel-out” position. When the telescoping luggage handle shaft is expanded, i.e. when the handle is pulled out of the luggage, the inner handle shaft is withdrawn from within the outer handle shaft. The handle contact structure at the bottom end of the inner handle shaft is removed from contact with the slide and moves up the outer handle shaft. Because of the movement of the handle contact structure up the outer handle shaft, the slide hole 411 is cleared and the top incline surface of the slide moves through the slide hole due to the force applied by the expansion of the slide spring. Due to the inward movement of the slide, the peak of the convex wheel housing contact member (horizontal peak area) is brought into contact with the low point of the slide notch. In one aspect of the invention, the peak of the convex wheel housing contact member and the low point of the slide notch are both flat, horizontal surfaces. The bringing into contact of the peak of the convex wheel housing contact member with the low point of the slide notch causes the wheel housing to move downward. The downward movement of the wheel housing causes the wheel to extend, i.e. to move outward from the bottom surface of the luggage.

Having disclosed exemplary embodiments and the best mode, modifications and variations may be made to the disclosed embodiments while remaining within the subject and spirit of the invention as defined by the following claims.

1. A container wheel control mechanism, comprising:
a container handle, mechanically coupled to a container, configured to expand and compress;
a container wheel mechanically coupled to the container handle and responsive to movement of the container handle, configured to extend from the surface of the container when the container handle is expanded and to retract from the surface of the container when the container handle is compressed.

2. The control mechanism of claim 1, wherein number of container wheels is two, including a first container wheel and a second container wheel, and wherein the container handle comprises a first telescoping handle shaft and a second telescoping handle shaft.

3. The control mechanism of claim 2, wherein the first telescoping handle shaft controls the extension and retraction of the first container wheel and the second telescoping handle shaft controls the extension and retraction of the second container wheel.

4. The control mechanism of claim 2, wherein the first telescoping handle shaft is comprised of a first inner handle shaft and a first outer handle shaft, wherein the first inner handle shaft is configured to slide through the first outer handle shaft; and wherein the second telescoping handle shaft is comprised of a second inner handle shaft and a second outer handle shaft, wherein the second inner handle shaft is configured to slide through the second outer handle shaft.

5. The control mechanism of claim 4, wherein the first inner handle shaft and the first outer handle shaft and the second inner handle shaft and the second outer handle shaft are not pipes.

6. The control mechanism of claim 1, further comprising:
a wheel housing to house the container wheel, the container wheel being fixed about an axle of the wheel housing; and
a slide slidingly coupled to the wheel housing and to the container handle to control movement of the container wheel, wherein, when the container handle is compressed, sliding contact of the container handle against the slide causes the wheel housing and the wheel to retract into the container recess; and wherein, when the container handle is expanded, sliding contact of the wheel housing against the slide causes the wheel housing and the wheel to extend from the container recess.

7. The control mechanism of claim 6, wherein the wheel housing has a convex wheel housing contact member and a horizontal peak area at top of wheel housing; and wherein the convex wheel housing contact member couples to a notch at bottom of the slide when the container wheel is retracted and wherein the horizontal peak area of the wheel housing couples with a horizontal area at the bottom of the slide when the container wheel is extended.

8. The control mechanism of claim 7, further comprising a wheel spring coupled to the slide and the wheel housing to move the wheel housing into the slide notch by tension force to retract the container wheel.

9. The control mechanism of claim 6, wherein top of slide has a top incline surface to slidingly couple with the container handle, wherein when the container handle is compressed, bottom end of the container handle slidingly couples with the top incline surface of the slide to cause the container wheel to retract.

10. The control mechanism of claim 9, further comprising a slide spring coupled to the slide and the container to push the top incline surface of the slide into contact with the bottom end of the container handle.

11. A method for controlling a container wheel, comprising:
retracting the container wheel in response to compression of a container handle; and
extending the container wheel in response to expansion of the container handle.

12. The method of claim 11, wherein the compression of the container handle further comprises moving the handle in a trajectory that is perpendicular towards a bottom surface of the container.

13. The method of claim 11, wherein the expansion of the container handle further comprises moving the handle in a trajectory that is perpendicular away from the bottom surface of the container.
